(19) United States
(12) Patent Application Publication
(10) Pub. No.: US 2023/0188924 A1
(43) Pub. Date: Jun. 15, 2023

(54) Spatial Audio Object Positional Distribution within Spatial Audio Communication Systems

(71) Applicant: Nokia Technologies Oy, Espoo (FI)

(72) Inventors: Mikko Tapio Tammi, Tampere (FI); Miikka Tapani Vilermo, Siuro (FI); Arto Juhani Lehtiniemi, Lempaala (FI)

(21) Appl. No.: 18/076,872

(22) Filed: Dec. 7, 2022

(30) Foreign Application Priority Data
Dec. 10, 2021 (GB) 2117888.4

(51) Int. Cl. H04S 7/00; G10L 25/78; G06V 40/16

(52) U.S. Cl. CPC H04S 7/303; G10L 25/78; G06V 40/161

(57) ABSTRACT

An apparatus for delivering spatial audio, the apparatus including circuitry configured to: obtain at least one audio signal and first metadata and second metadata, the first metadata includes at least one first spatial parameter associated with a first sound object from a first group of sound objects and the second metadata including at least one second spatial parameter associated with a second sound object from a second group of sound objects; and low-bitrate encode a spatial audio signal based on the at least one audio signal, the at least one first spatial parameter and the at least one second spatial parameter, wherein the spatial audio signal includes a controlled version of at least one of the first and second sound objects respectively by the at the at least one first and second spatial parameters.

### FIELD

The present application relates to apparatus and methods for spatial audio object positional distribution within spatial audio communication systems, and specifically but not exclusively spatial audio teleconference communication systems.

### BACKGROUND

Spatial audio capture with microphone arrays is utilized in many modern digital devices such as mobile devices and cameras, in many cases together with video capture. Spatial audio capture can be played back with headphones or loudspeakers to provide the user with an experience of the audio scene captured by the microphone arrays.

Parametric spatial audio capture methods enable spatial audio capture with diverse microphone configurations and arrangements, thus can be employed in consumer devices, such as mobile phones. Parametric spatial audio capture methods are based on signal processing solutions for analysing the spatial audio field around the device utilizing available information from multiple microphones. Typically, these methods perceptually analyse the microphone audio signals to determine relevant information in frequency bands. This information includes for example direction of a dominant sound source (or audio source or audio object) and a relation of a source energy to overall band energy. Based on this determined information the spatial audio can be reproduced, for example using headphones or loudspeakers. Ultimately the user or listener can thus experience the environment audio as if they were present in the audio scene within which the capture devices were recording.

The better the audio analysis and synthesis performance the more realistic is the outcome experienced by the user or listener.

### SUMMARY

There is provided according to a first aspect an apparatus for delivering spatial audio, the apparatus comprising means configured to: obtain at least one audio signal and first metadata and second metadata, the first metadata comprises at least one first spatial parameter associated with a first sound object from a first group of sound objects and the second metadata comprising at least one second spatial parameter associated with a second sound object from a second group of sound objects; and low-bitrate encode a spatial audio signal based on the at least one audio signal, the at least one first spatial parameter and the at least one second spatial parameter, wherein the spatial audio signal comprises a controlled version of at least one of the first and second sound objects respectively by the at the at least one first and second spatial parameters.

The controlled version of at least one of the first and second sound objects respectively by the at least one first and second spatial parameters may comprise the means configured to control at least one of: amplify audio signals associated with the at least one of the first and second sound objects; attenuate audio signals associated with the at least one of the first and second sound objects; and modify at least one of the at least one first and second spatial parameters.

The means configured to modify at least one of the at least one first and second spatial parameters may be configured to modify at least one direction or position for at least one of the at least one first sound object or at least one second sound object.

The means configured to low-bitrate encode the spatial audio signal based on the at least one audio signal, the at least one first spatial parameter and the at least one second spatial parameter may be configured to at least partially discard the association between the first metadata and the first sound object from the first group of sound objects and the second metadata and the second sound object from the second group of sound objects.

The means configured to obtain at least one audio signal and first metadata and second metadata may be configured to: obtain a first sound object audio signal and the first metadata; obtain a second sound object audio signal and the second metadata; and the means configured to low-bitrate encode the spatial audio signal based on the at least one audio signal, the at least one first spatial parameter and the at least one second spatial parameter is configured to mix the first sound object audio signal and the second sound object audio signal to generate the spatial audio signal, wherein the mix is based on the at least one first spatial parameter and/or the at least one second spatial parameter.

The means configured to obtain at least one audio signal and first metadata and second metadata may be configured to: identify at least two physical sound sources; and associate for each of the at least two physical sound sources one of sound objects.

The means configured to identify at least two physical sound sources may be configured to apply at least one of: statistical analysis to the directions or positions to identify directions or positions to which the directions or positions accumulate; speech detection to identify whether audio signals in the directions or positions are speech to identify at least two physical sound sources; and face tracking to associated video images to identify at least two physical sound sources.

The means configured to obtain at least one audio signal and first metadata and second metadata may be configured to allocate at least one sound source associated with the first metadata and the second metadata consistently to at least one direction or position.

The means configured to allocate at least one sound source associated with the first metadata and the second metadata may be configured to at least one of: detect the direction and energy ratio of a strongest sound; associate the detected strongest sound to the nearest at least one direction or position; detect the direction and energy ratio of a second strongest sound; and associate the detected second strongest sound to the nearest at least one direction or position. According to a second aspect there is provided a method for an apparatus for delivering spatial audio, the method comprising: obtaining at least one audio signal and first metadata and second metadata, the first metadata comprises at least one first spatial parameter associated with a first sound object from a first group of sound objects and the second metadata comprising at least one second spatial parameter associated with a second sound object from a second group of sound objects; and low-bitrate encoding a spatial audio signal based on the at least one audio signal, the at least one first spatial parameter and the at least one second spatial parameter, wherein the spatial audio signal comprises a controlled version of at least one of the first and second sound objects respectively by the at the at least one first and second spatial parameters.

The controlled version of at least one of the first and second sound objects respectively by the at least one first and second spatial parameters may comprise controlling at least one of: amplify audio signals associated with the at least one of the first and second sound objects; attenuate audio signals associated with the at least one of the first and second sound objects; and modify at least one of the at least one first and second spatial parameters.

Modifying at least one of the at least one first and second spatial parameters may comprise modifying at least one direction or position for at least one of the at least one first sound object or at least one second sound object.

Low-bitrate encoding the spatial audio signal based on the at least one audio signal, the at least one first spatial parameter and the at least one second spatial parameter may comprise at least partially discarding the association between the first metadata and the first sound object from the first group of sound objects and the second metadata and the second sound object from the second group of sound objects.

Obtaining at least one audio signal and first metadata and second metadata may comprise: obtaining a first sound object audio signal and the first metadata; obtaining a second sound object audio signal and the second metadata; and low-bitrate encoding the spatial audio signal based on the at least one audio signal, the at least one first spatial parameter and the at least one second spatial parameter comprises mixing the first sound object audio signal and the second sound object audio signal to generate the spatial audio signal, wherein the mixing is based on the at least one first spatial parameter and/or the at least one second spatial parameter.

Obtaining at least one audio signal and first metadata and second metadata may comprise: identifying at least two physical sound sources; and associating for each of the at least two physical sound sources one of sound objects.

Identifying at least two physical sound sources may comprise at least one of: applying statistical analysis to the directions or positions to identify directions or positions to which the directions or positions accumulate; applying speech detection to identify whether audio signals in the directions or positions are speech to identify at least two physical sound sources; and applying face tracking to associated video images to identify at least two physical sound sources.

Obtaining at least one audio signal and first metadata and second metadata may comprise allocating at least one sound source associated with the first metadata and the second metadata consistently to at least one direction or position.

Allocating at least one sound source associated with the first metadata and the second metadata may comprise at least one of: detecting the direction and energy ratio of a strongest sound; associating the detected strongest sound to the nearest at least one direction or position; detecting the direction and energy ratio of a second strongest sound; and associating the detected second strongest sound to the nearest at least one direction or position.

According to a third aspect there is provided an apparatus for delivering spatial audio, the apparatus comprising at least one processor and at least one memory including a computer program code, the at least one memory and the computer program code configured to, with the at least one processor, cause the apparatus at least to: obtain at least one audio signal and first metadata and second metadata, the first metadata comprises at least one first spatial parameter associated with a first sound object from a first group of sound objects and the second metadata comprising at least one second spatial parameter associated with a second sound object from a second group of sound objects; and low-bitrate encode a spatial audio signal based on the at least one audio signal, the at least one first spatial parameter and the at least one second spatial parameter, wherein the spatial audio signal comprises a controlled version of at least one of the first and second sound objects respectively by the at the at least one first and second spatial parameters.

The controlled version of at least one of the first and second sound objects respectively by the at least one first and second spatial parameters may comprise the apparatus caused to control at least one of: amplify audio signals associated with the at least one of the first and second sound objects; attenuate audio signals associated with the at least one of the first and second sound objects; and modify at least one of the at least one first and second spatial parameters.

The apparatus caused to modify at least one of the at least one first and second spatial parameters may be caused to modify at least one direction or position for at least one of the at least one first sound object or at least one second sound object.

The apparatus caused to low-bitrate encode the spatial audio signal based on the at least one audio signal, the at least one first spatial parameter and the at least one second spatial parameter may be caused to at least partially discard the association between the first metadata and the first sound object from the first group of sound objects and the second metadata and the second sound object from the second group of sound objects.

The apparatus caused to obtain at least one audio signal and first metadata and second metadata may be caused to: obtain a first sound object audio signal and the first metadata; obtain a second sound object audio signal and the second metadata; and the means configured to low-bitrate encode the spatial audio signal based on the at least one audio signal, the at least one first spatial parameter and the at least one second spatial parameter is configured to mix the first sound object audio signal and the second sound object audio signal to generate the spatial audio signal, wherein the mix is based on the at least one first spatial parameter and/or the at least one second spatial parameter.

The apparatus caused to obtain at least one audio signal and first metadata and second metadata may be caused to: identify at least two physical sound sources; and associate for each of the at least two physical sound sources one of sound objects.

The apparatus caused to identify at least two physical sound sources may be caused to apply at least one of: statistical analysis to the directions or positions to identify directions or positions to which the directions or positions accumulate; speech detection to identify whether audio signals in the directions or positions are speech to identify at least two physical sound sources; and face tracking to associated video images to identify at least two physical sound sources.

The apparatus caused to obtain at least one audio signal and first metadata and second metadata may be caused to allocate at least one sound source associated with the first metadata and the second metadata consistently to at least one direction or position.

The apparatus caused to allocate at least one sound source associated with the first metadata and the second metadata may be caused to at least one of: detect the direction and energy ratio of a strongest sound; associate the detected strongest sound to the nearest at least one direction or position; detect the direction and energy ratio of a second strongest sound; and associate the detected second strongest sound to the nearest at least one direction or position.

According to a fourth aspect there is provided an apparatus comprising: means for obtaining at least one audio signal and first metadata and second metadata, the first metadata comprises at least one first spatial parameter associated with a first sound object from a first group of sound objects and the second metadata comprising at least one second spatial parameter associated with a second sound object from a second group of sound objects; and means for low-bitrate encoding a spatial audio signal based on the at least one audio signal, the at least one first spatial parameter and the at least one second spatial parameter, wherein the spatial audio signal comprises a controlled version of at least one of the first and second sound objects respectively by the at the at least one first and second spatial parameters.

According to a fifth aspect there is provided a computer program comprising instructions [or a computer readable medium comprising program instructions] for causing an apparatus to perform at least the following: obtain at least one audio signal and first metadata and second metadata, the first metadata comprises at least one first spatial parameter associated with a first sound object from a first group of sound objects and the second metadata comprising at least one second spatial parameter associated with a second sound object from a second group of sound objects; and low-bitrate encode a spatial audio signal based on the at least one audio signal, the at least one first spatial parameter and the at least one second spatial parameter, wherein the spatial audio signal comprises a controlled version of at least one of the first and second sound objects respectively by the at the at least one first and second spatial parameters.

According to a sixth aspect there is provided a non-transitory computer readable medium comprising program instructions for causing an apparatus to perform at least the following: obtain at least one audio signal and first metadata and second metadata, the first metadata comprises at least one first spatial parameter associated with a first sound object from a first group of sound objects and the second metadata comprising at least one second spatial parameter associated with a second sound object from a second group of sound objects; and low-bitrate encode a spatial audio signal based on the at least one audio signal, the at least one first spatial parameter and the at least one second spatial parameter, wherein the spatial audio signal comprises a controlled version of at least one of the first and second sound objects respectively by the at the at least one first and second spatial parameters.

According to a seventh aspect there is provided an apparatus comprising: obtaining circuitry configured to obtain at least one audio signal and first metadata and second metadata, the first metadata comprises at least one first spatial parameter associated with a first sound object from a first group of sound objects and the second metadata comprising at least one second spatial parameter associated with a second sound object from a second group of sound objects; and encoding circuitry configured to low-bitrate encode a spatial audio signal based on the at least one audio signal, the at least one first spatial parameter and the at least one second spatial parameter, wherein the spatial audio signal comprises a controlled version of at least one of the first and second sound objects respectively by the at the at least one first and second spatial parameters.

According to an eighth aspect there is provided a computer readable medium comprising program instructions for causing an apparatus to perform at least the following: obtain at least one audio signal and first metadata and second metadata, the first metadata comprises at least one first spatial parameter associated with a first sound object from a first group of sound objects and the second metadata comprising at least one second spatial parameter associated with a second sound object from a second group of sound objects; and low-bitrate encode a spatial audio signal based on the at least one audio signal, the at least one first spatial parameter and the at least one second spatial parameter, wherein the spatial audio signal comprises a controlled version of at least one of the first and second sound objects respectively by the at the at least one first and second spatial parameters.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows schematically example apparatus for implementing spatial capture and playback according to some embodiments;

FIG. 2 shows a flow diagram of the operations of the apparatus shown in FIG. 1 according to some embodiments;

FIG. 3 shows schematically an example teleconference system within which embodiments can be implemented;

FIG. 4 shows schematically an example teleconference server as shown within the teleconference system shown in FIG. 3 according to some embodiments;

FIG. 5 shows a flow diagram of the operations of the example teleconference server shown in FIG. 4 according to some embodiments;

FIG. 6 shows schematically an example spatial mixer as shown within the teleconference server shown in FIG. 4 according to some embodiments;

FIG. 7 shows a flow diagram of the operations of the example spatial mixer shown in FIG. 6 according to some embodiments;

FIG. 8 shows an example graph of direction estimate for two equally loud inputs;

FIG. 9 shows an example situation of a mono teleconferencing system where sound sources are heard from the same direction;

FIG. 10 shows an example situation of a spatial teleconferencing system where sound sources are heard from various directions without source direction modification;

FIG. 11 shows an example situation of a spatial teleconferencing system where sound sources are heard from various directions with source direction modification; and

FIG. 12 shows schematically an example device suitable for implementing the apparatus shown.

### EMBODIMENTS OF THE APPLICATION

The concept as discussed herein in further detail with respect to the following embodiments is related to the presentation and delivery of parametric spatial audio signals.

State-of-the-art example of parametric spatial audio capture is utilized widely in modern mobile devices for audio capture and have been extended also to spatial communication use. In communication solutions, an efficient coding solution is needed for the spatial audio.

Modern audio codecs support coding of parametric spatial data. For example a 3GPP IVAS audio encoder can be configured to encode audio in a parametric format so that there are audio tracks and audio parameters (metadata) related to the audio. Audio parameters include at least sound source directions and energy ratios such as direct-to-ambient (D/A) ratio. An IVAS audio decoder can be configured to receive the audio tracks and related metadata and render the audio spatially to stereo, binaural, 5.1, etc.

Using spatial audio in teleconferencing applications has recently gained interest. When there are multiple persons joining the conference from different locations, participants can be spatially positioned into different directions around the listeners, which makes it easier for the listener to follow the conversation and differentiate sources from each other. This kind of approach is feasible when the audio signal originating from each user is mono or mixed to mono. Mixing directly spatial signals from each user without making them first mono can result in a messy outcome with sources and background signals on top of each other. Also, when user receives simultaneously another audio source (UI sounds, YouTube audio etc.) the spatial audio space may be divided so that YouTube audio is in the front and spatial audio from a phone call or teleconference is at a side.

If audio metadata allows more than one direction for each time frequency tile, it can be utilized to improve spatial quality when there are more than one sound source or strong ambience present. For example IVAS audio codecs and Nokia OZO Audio allow using two directions for each time-frequency tile. By modifying first the direction data IVAS audio decoder may render the first and second direction differently in cases where the spatial rendering is limited. The decoder may modify the first and second direction to be fixed or to compress their range for example from 360 degrees to 90 degrees.

When there are multiple persons in the same location participating into teleconference and audio is spatial, the great benefit of spatial audio is that at the other end those participants can be heard from different directions. However, when there are multiple participants from different locations in the teleconference the audio from one location is often played back from a single direction. This causes persons in the same location to be heard from a single direction, i.e. there is no spatial separation between those persons. It is the aim of embodiments as described hereafter to enable spatial separation or object separation in an efficient and listener acceptable manner.

Object separation is an audio capture solution in which captured audio is separated into individual sound objects. One might think that generating separate audio object from each participant in the same location might enable targeted functionality, i.e. the persons could be processed as independent sources in the teleconferencing system. However, reliable object separation is a very challenging and complex task, often resulting in poor audio quality. For example, background noise and varying number of sources are challenges for current object separation approaches. Object separation also typically introduces algorithmic delay, which is not preferred in teleconference or other real time communication applications

Parametric spatial audio codecs which support two (or more) direction parameters for every time-frequency tile provide more spatial information to the decoder than earlier implementations, enabling more advanced usage of the spatial data. Encoders/pre-processors currently associate a first direction to the loudest directional sound source and a second direction to the second loudest sound source. This means that when the sound sources' relative loudness changes from time to time, the first and second directions can be associated with different sound source at different times. When the playback is limited, one might want to simplify spatial information but still maintain part of the spatial properties, for example allocate two persons in the same location to fixed (not original) spatial angles such that they can be perceptually separated when listening the playback. Even though there are two direction parameters in the bit stream, currently is not allowed or reliably possible to separate those two persons as the association of the direction data is not based on sources but on loudness.

The implementations and the embodiments described herein attempt to improve on current approaches and overcome the issue when the playback device play back sounds associated to the first direction index from angle α₁ and second from angle α₂, and the recorded sound sources continuously change positions based on their relative loudness. In addition, the embodiments aim to allow the user of the playback device to adjust the properties of the sources, for example levels of the sound sources to make them equally loud.

Furthermore the embodiments described herein aim to overcome the issue that using object separation methods requires transmitting the results separately, which requires processing, bitrate, transmission protocol etc. In the embodiments described herein the benefit from object separation can be achieved using existing parametric spatial audio encoder features.

In summary it is known to separate audio to parts and then associate the parts with sound sources. The separated object can be encoded into separate streams and transmitted. It is also known to encode spatial audio parametrically using one or more direction parameters per frequency band. However, presenting object separation results in a form that a parametric spatial audio encoder automatically uses so that object separation is maintained in correct directions, is not known. Object separation here means both traditional object separation and simpler methods where directions are merely split to ranges and each range is assumed to be an object.

MPEG SAOC (Spatial Audio Object Coding) is a coding system that takes in audio objects and compresses them into a mono or stereo audio stream with metadata. The objects can later be partially separated and playback is spatial.

The embodiments herein differ from the object separation method described herein in not requiring the objects to be separately encoded or to have gain parameters (in metadata) to partially separate the objects. As such the embodiments aim to reduce the requirements for very high bitrates as found in current object separation techniques. For example separately encoding objects currently requires ˜30 kbps/object minimum (total bitrate is NumberOfObjects times 30 kbps). An example of encoding each object in a separate channel is the upcoming 3GPP IVAS audio encoder. An example of mixing audio object and enabling partial separation capability using gain parameters is MPEG SAOC. SAOC typically operates at bitrates 164 kbps or higher. Whereas the embodiments described herein can reach very low bitrates around 24 kbps total.

Furthermore the embodiments as described herein enable the gain parameters to be available and as such makes it possible to have multiple objects in a mix using only direction metadata.

The concept as discussed with respect to the embodiments described herein can thus be summarised as relating to delivering parametric spatial audio where there is provided mixed sound signal of the audio objects and directional information about them. In such embodiments the aim is to achieve the delivery of object signals with a low bit rate, to be able to control audio object directions, levels and other characteristics, and to generate spatial representation of the audio signal. This can be achieved as described in the embodiments herein in further detail by utilizing the directional metadata with two direction and energy ratio parameters for every time-frequency tile, readily available in IVAS, such that objects are allocated into metadata parameters.

The applications of such embodiments can include:

tele-conference systems (telco), where one participating device sounds are limited to a direction and local user may control audio objects separately and hear them from different directions;

spatial audio UI, where an application sounds are limited to application direction;

audio recording/telecommunication where user wants to control one sound object in the mixture but not the other; and

playing audio when a notification appears and device limits audio direction range.

As discussed previously parametric spatial coders have supported only one direction and energy ratio parameter for every time-frequency tile. The upcoming 3GPP IVAS standard will support two directions. Typically, directions are allocated such that the first direction points to the direction of the strongest audio source, and the second direction points to the second strongest source. This is a good solution if the purpose is to capture spatial audio with good spatial quality.

However, as employed in the embodiments described herein, depending on the use case these two directions can be utilized also differently. By systematically allocating the first direction to one sound source and the second to another source it is possible to enable different functionalities at the playback end or alternatively in the teleconference server which mixes audio signals originating from multiple participants.

This type of allocation of sound sources to audio coding direction parameters maintains backwards compatibility and does not interfere with the parametric spatial audio in any way.

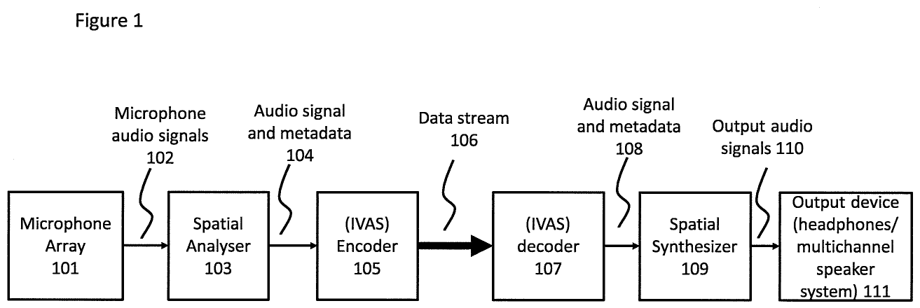

FIG. 1 shows schematically an example system or apparatus within which some embodiments may be employed.

In this example is shown the apparatus comprising a microphone array 101. The microphone array 101 comprises multiple (two or more) microphones configured to capture audio signals. The microphones within the microphone array can be any suitable microphone type, arrangement or configuration. The microphone audio signals 102 generated by the microphone array 101 can be passed to the spatial analyser 103.

The apparatus can comprise a spatial analyser 103 configured to receive or otherwise obtain the microphone audio signals 102 and is configured to spatially analyse the microphone audio signals in order to determine at least two dominant sound or audio sources for each time-frequency block.

The spatial analyser can in some embodiments be a CPU of a mobile device or a computer. The spatial analyser 103 is configured to generate a data stream which includes audio signals as well as metadata of the analyzed spatial information 104.

Depending on the use case, the data stream can be stored or compressed and transmitted to another location. For example as shown in FIG. 1 the apparatus comprises a (IVAS) encoder 105 configured to obtain the audio signals (or some transport related audio signal based on the audio signals) and the metadata and encode these to generate a bitstream 106 suitable for storage or transmission. In this example the spatial analysis output is a IVAS compatible MASA (metadata-assisted spatial audio) format which can be fed directly into an IVAS encoder. The IVAS encoder generates a IVAS data stream.

Furthermore there is shown a (IVAS) decoder 107 configured to obtain the bitstream 106 and from the bitstream generate the metadata and audio signals 108. In some embodiments the (IVAS) decoder 107 is able to implement or employ some spatial synthesis. For example a IVAS decoder is specified to implement basic spatial synthesis. In these embodiments a partially synthesized audio signal is passed to the (object modifying) spatial synthesizer 109. In some embodiments the decoder is configured to pass the transport audio signals and the metadata without initial spatial synthesis to a spatial synthesizer 109 (and the object modifying spatial synthesizer 109 is configured to implement the initial spatial synthesis). Thus in summary the (IVAS) decoder is in some embodiments capable of producing an initial processing of the transport audio signals and which are further modified by the object modifying spatial synthesizer 109.

The apparatus furthermore comprises a (object modifying) spatial synthesizer 109. The (object modifying) spatial synthesizer 109 is configured to obtain the audio signals and the metadata 108 (of which may be initially spatial synthesized as indicated above). In some embodiments (object modifying) spatial synthesizer 109 is implemented within the same apparatus as the spatial analyser 103 (as shown herein in FIG. 1) but can furthermore in some embodiments be implemented within a different apparatus or device. In the following examples the (object modifying) spatial synthesizer 109 is configured to implement both the initial and the object modifying spatial synthesis but as discussed above these operations can be separated.

The (object modifying) spatial synthesizer 109 can be implemented within a CPU or similar processor. The (object modifying) spatial synthesizer 109 is configured to produce output audio signals 110 based on the audio signals and associated metadata 108.

Furthermore depending on the use case, the output signals 110 can be any suitable output format. For example in some embodiments the output format is binaural headphone signals (where the output device presenting the output audio signals is a set of headphones/earbuds or similar) or multichannel loudspeaker audio signals (where the output device is a set of loudspeakers).

The output device 111 (which as described above can for example be headphones or loudspeakers) can be configured to receive the output audio signals 110 and present the output to the listener or user.

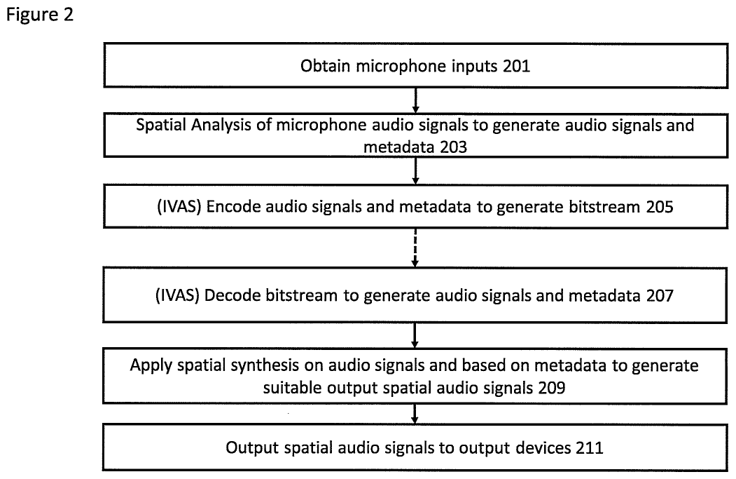

These operations of the example apparatus shown in FIG. 1 can be shown by the flow diagram shown in FIG. 2. The operations of the example apparatus thus be summarized as the following.

Obtaining the microphone audio signals as shown in FIG. 2 by step 201.

Spatially analysing the microphone audio signals to generate audio signals and metadata comprising directions and energy ratios for a first and second audio source for each time-frequency tile as shown in FIG. 2 by step 203. In some embodiments the generated audio signals are spatial audio signals.

(IVAS) encoding the audio signals and metadata to generate a bitstream as shown in FIG. 2 by step 205.

In some embodiments the bitstream is stored/transmitted.

There is then a (IVAS) decoding of the bitstream to generate the audio signals and metadata as shown in FIG. 2 by step 207.

Applying (both initial and object modifying) spatial synthesis to the audio signals to generate suitable output spatial audio signals as shown in FIG. 2 by step 209.

Outputting the output spatial audio signals to the output device as shown in FIG. 2 by step 211.

As discussed previously there are multiple different use cases for the embodiments disclosed herein. The use cases have commonly spatial objects that can be controlled in a meaningful way to meet the targets of the application. In the following examples the use or application of the embodiments described herein is a teleconferencing system, but it should be understood that similar spatial modifications can be used in other use cases as well.

In teleconference systems, when there are multiple simultaneous participants (clients) with spatial capture support the mixing of the content can be implemented in a centralized manner.

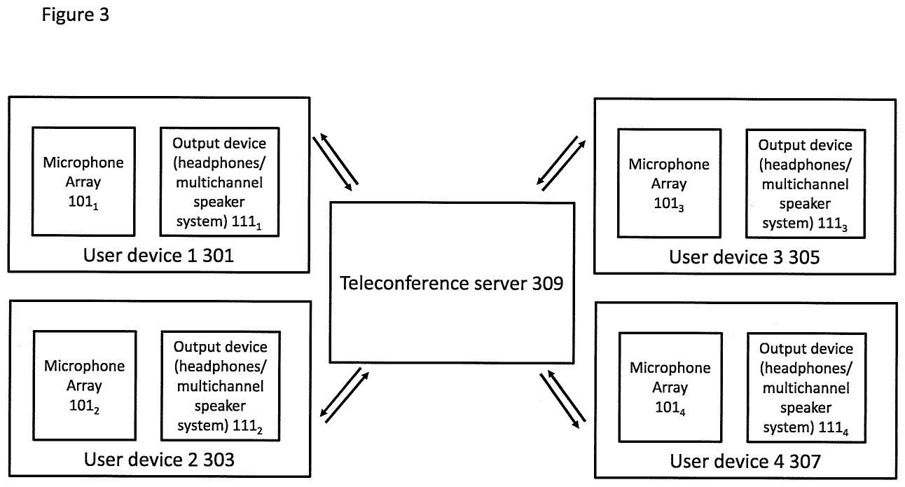

For example as shown in FIG. 3 there is shown a teleconference system with four simultaneous users in a teleconference. In this example there is shown four user devices, user device 1 301 comprising a microphone array 101₁ and output device 111₁, user device 2 303 comprising a microphone array 101₂ and output device 111₂, user device 3 305 comprising a microphone array 101₃ and output device 111₃, user device 4 307 comprising a microphone array 101₄ and output device 111₄. Additionally the system comprises a teleconference server 309 configured in this example to perform the mixing of spatial signals individually for each user device. For example, the downlink of the user device 1 301 contains spatial mixture of the sound sources originating from user device 2 303, user device 3 305 and user device 4 307. In some embodiments not all user devices within the teleconference system have to utilize spatial capture. In other words some of the uploaded audio signals or sources can be mono audio signals.

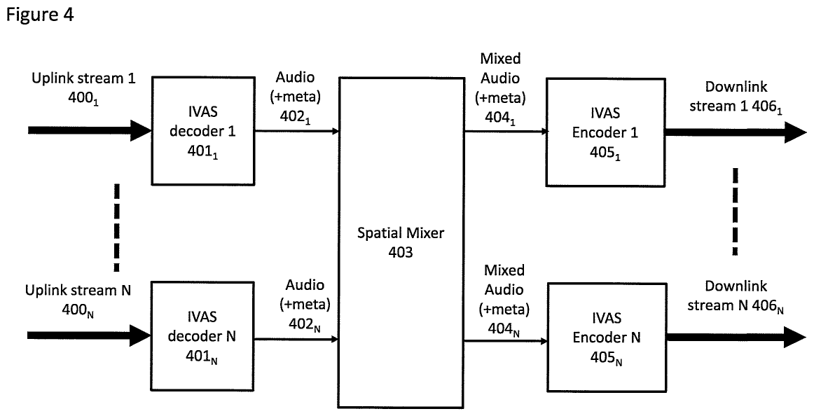

FIG. 4 shows schematically the teleconference server in further detail presenting a more detailed picture what happens inside the teleconference server 309. The teleconference server 309 in some embodiments is configured to receive two or more uplink stream inputs. In the example shown in FIG. 1 there is shown uplink stream 1 400₁ and uplink stream N 400_{N}. In this example the uplink streams can be spatial or non-spatial uplink streams.

The teleconference server 309 furthermore may comprise one or more (IVAS) decoders. For example in some embodiments there can be a separate decoder for each input stream. Thus for example there is shown a IVAS decoder 1 401₁ configured to receive uplink stream 1 400₁ and generate a audio signal and metadata 402₁, and a IVAS decoder N 401_{N} configured to receive uplink stream N 400₁ and generate a N stream audio signal and metadata 402_{N}. The output of each of the decoders can then be passed to the spatial mixer 403. In this example IVAS coding/decoding is implemented, but also other suitable coding formats can be employed.

In some embodiments the teleconference server 309 comprises a spatial mixer 403. The spatial mixer is configured to receive the outputs of the decoders and mix the audio signals. For example in some embodiments out of the N uplink signals the spatial mixer is configured to generate N different downlink signals. For example FIG. 3 shows the spatial mixer 403 configured to generate a mixed audio and metadata 404₁ and a N stream mixed audio and metadata 404_{N}. In the spatial mixer audio signals from all users are combined. Typically, it makes no sense to directly combine all spatial signals together as it results in a messy outcome with all sound sources and ambiences on top of each other. Instead, a common solution is to make all uplink streams mono and allocate each mono signal to a selected spatial direction. For example in the case of three audio signals one might allocate sources to −90, 0 and 90 degrees to the downlink stream. Alternatively to maintain spatial ambience of one of the sources and mix other signals as mono on top of that.

The teleconference server 309 furthermore in some embodiments comprises a set of encoders 405 configured to receive the mixed audio signals (and metadata) 404₁ and 404_{N} and encode each to generate a downlink stream 406. For example is shown IVAS encoder 1 405₁ configured to receive the mixed audio and metadata 404₁ and generate downlink stream 1 406₁ (which can be delivered to the user device 1) and IVAS encoder N 405_{N} configured to receive the mixed audio and metadata 404_{N} and generate downlink stream N 406_{N} (which can be delivered to the user device N).

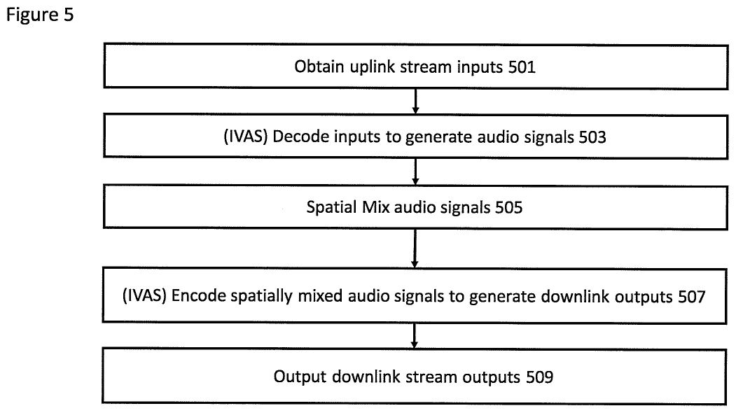

With respect to FIG. 5 is shown a flow diagram of the operations of the spatial mixer as shown in FIG. 4 according to some embodiments.

Thus for example the uplink streams inputs are obtained as shown in FIG. 5 by step 501.

The uplink streams are then decoded to generate audio signals as shown in FIG. 5 by step 503.

The audio signals are then spatial audio mixed as shown in FIG. 5 by step 505.

The mixed audio signals are then encoded as shown in FIG. 5 by step 507.

The encoded mixed audio signals are then output as downlink stream outputs as shown in FIG. 5 by step 509.

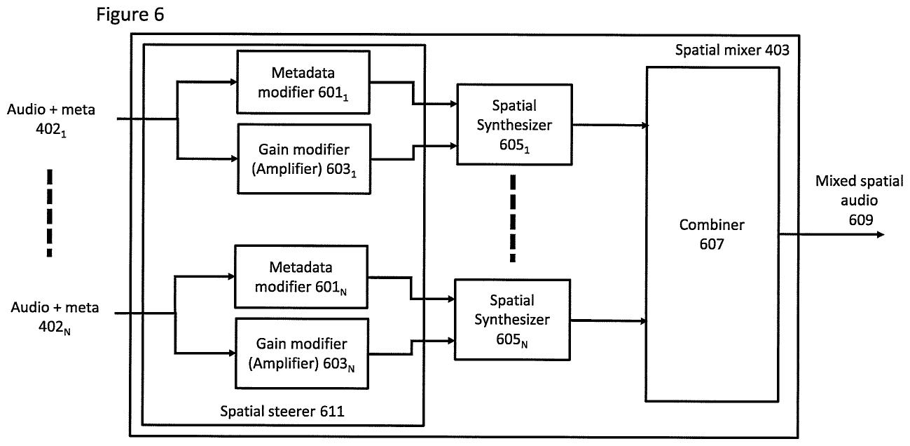

FIG. 6 furthermore shows an example spatial mixer 403 in further detail. In some embodiments the spatial mixer 403 comprises a spatial steerer 611. The spatial steerer 611 is configured to receive the audio and meta signals 402. There are N audio+metadata stream inputs to the system as shown in FIG. 6 by 402₁ and 402_{N}. Spatial steering is used over all inputs to generate suitable mix out of the signals.

The spatial steerer 611 is configured to divide each input stream into metadata and audio paths.

The spatial steerer 611 comprises for each input stream a metadata modifier 601 and a gain modifier 603. For example as shown in FIG. 6 there is a first metadata modifier 601₁ and a gain modifier 603₁ configured to receive the metadata and audio signals respectively for the first input stream and a Nth metadata modifier 601_{N} and a gain modifier 603_{N} configured to receive the metadata and audio signals respectively for the N input stream.

The metadata modifier 601 is configured to modify the metadata, for example the spatial environment with sources in many directions can be replaced with a mono signal which is spatially allocated to angle αₙ.

The gain modifier 603 is configured to modify the audio signal by applying a gain value, the gain values gₙ being used to adjust the levels of the input audio signals. For example, the levels of the N inputs can be adjusted such that they sound equally loud.

In addition, the gain modifier 603 is configured such that for user n the audio originating from his/her source is not included. In other words the gain modifier 603 is configured for the downlink stream n, to set the gain gₙ to zero.

The output of the metadata modifier 601 and the gain modifier 603 is fed to a respective spatial synthesizer 605. Thus for example the outputs from the first metadata modifier 601₁ and the first gain modifier 603₁ are passed to a first spatial synthesizer 605₁ and the outputs from the N'th metadata modifier 601_{N} and the N'th gain modifier 603_{N} are passed to a N'th spatial synthesizer 605_{N}.

The spatial synthesizer 605 is configured to apply any suitable spatial synthesis approach and generate a suitable set of audio signals which can be passed to the combiner 607.

The spatial mixer 403 comprises a combiner 607. The combiner is configured to retrieve the output of the spatial synthesizer 605 and combine these to generate a mixed spatial audio 609.

It was discussed above that teleconference server typically converts all (or most) uplink signals to mono and spatial steering is used to allocate signal into specific spatial direction. Although this is reasonable solution when there is only one person participating to the teleconference at each end. Where there are for example two persons in one location, the teleconferencing system would allocate both of them to the same spatial direction in spatial mixing, in which case the benefit of spatial information is not utilized. These embodiments show how to allocate a direction to both (each) of those persons or user devices.

As mentioned previously (for example the IVAS standard supports) there can be two sound source directions for every time-frequency tile. Depending on the microphone array there are different alternatives how to estimate the two directions. In EP3791605 and GB2114186.6 a solution for estimating two directions for every time-frequency tile in a mobile device is introduced. Both above methods are build on top of SPAC capture techniques such as described in U.S. Pat. Nos. 9,456,289, 9,313,599, 10/382,849 and US2018199137.

Outside mobile technologies, there are methods for analysing two (or more) simultaneous directions. For example, the following two are for FOA and linear array input, respectively:
Thiergart, Oliver, and Emanuel A P Habets. “Robust direction-of-arrival estimation of two simultaneous plane waves from a B-format signal.” In IEEE 27th Convention of Electrical & Electronics Engineers in Israel (IEEEI), pp. 1-5. IEEE, 2012.
R. Roy and T. Kailath, “ESPRIT-estimation of signal parameters via rotational invariance techniques,” Acoustics, Speech and Signal Processing, IEEE Transactions on, vol. 37, no. 7, pp. 984-995, July 1989.

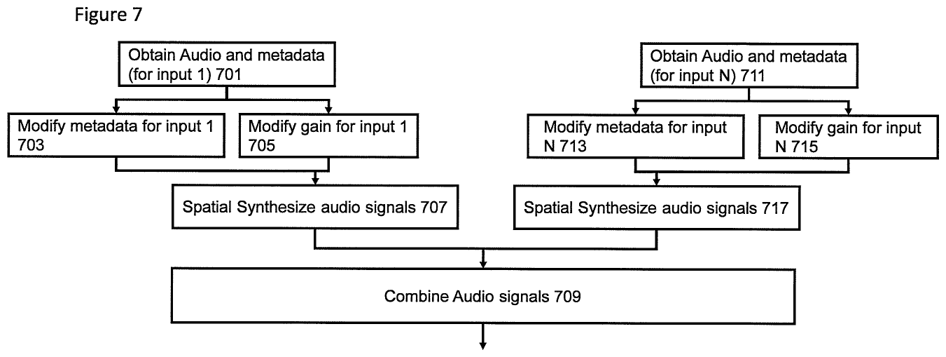

The operation of the example spatial mixer 403 is shown in the flow diagram of FIG. 7.

The initial operations are obtaining audio and metadata (for input 1) as shown in FIG. 7 by step 701 and obtaining audio and metadata (for input N) as shown in FIG. 7 by step 711.

Then the metadata is modified (for input 1) as shown in FIG. 7 by step 703. Furthermore the metadata is modified (for input N) as shown in FIG. 7 by step 713.

The gain and the audio signals are modified (for input 1) as shown in FIG. 7 by step 705. Additionally the gain and the audio signals are modified (for input N) as shown in FIG. 7 by step 715.

The spatial synthesis of the input 1 is shown in FIG. 7 by step 707. The spatial synthesis of the input N is shown in FIG. 7 by step 717.

The audio signals are then combined as shown in FIG. 7 by step 709.

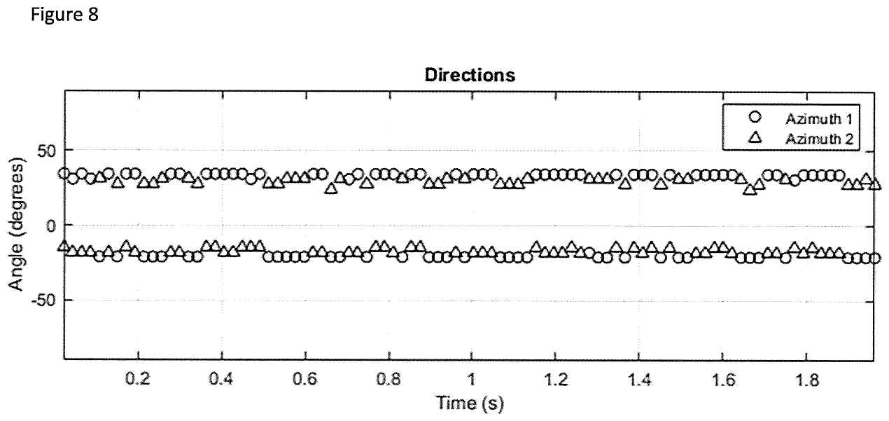

As described above existing systems allocate a first direction to the direction of the strongest source at the given moment. This results in situation as shown in FIG. 8. In this example there are two substantially equally loud sources present at angles 30 and −20 degrees. Depending on the time instant the direction of the strongest source varies as shown by the circle and triangle plots.

As the embodiments herein associate physical sound sources into parametric audio bit stream directions any inconsistency such as shown above would be problematic. Although in the example shown in FIG. 8 the directions of the two sources is obvious and would be corrected, real-life situations analysis results can be noisier and difficult to determine. In some embodiments the following methods can thus be used to determine and identify physical sound sources.

In some embodiments a statistical analysis can be performed to determine how the found source directions are distributed over a longer period of time. Directions to which most direction estimates accumulate can be considered as sound sources.

In some embodiments speech detection methods can be used to identify if sources in given direction are speech or some other source type. In these embodiments speech sources can be determined to be the most relevant ones.

In some embodiments where there is also video streams or images available, then object (for example instrument) or face tracking (for speech) can be utilized to assist determining the directions of the audio sources or speakers.

In some embodiments the teleconference server can determine whether there are one or two (or more) sound sources present at the client end. In some embodiments a data field included in the bit stream format can be employed to deliver this information. Alternatively, in some embodiments the information can be coded to the direction information, for example if the energy ratio of the second direction is zero there is only one sound source present at the client end.

In the metadata there are two direction indexes d1 and d2 available for every time-frequency tile, and both direction indexes contain information of the direction and the energy ratio. To make sure that the source directions do not change in the teleconference server the server is configured to allocate sources consistently into the same direction index.

For example, if we have two sources, s1 and s2, the server is configured to determine that the first source is always allocated to d1 and the second to d2. In embodiments where there are more than two sources, the server is configured to determine which ones of those sources are allocated to d1 and which ones to d2.

In some embodiments for a single time-frequency tile, only one of sources belonging to the same direction index can be active at a time. In other words the server can be configured to support two simultaneous directions but such that one must belong to d1 and the other to d2.

In some embodiments it is not obvious to which source and thus to which direction index the server is configured to allocate a new direction estimate. In such embodiments the following procedure can be implemented
1. Detect the direction θ₁ and energy ratio r₁ of the strongest sound in current time-frequency tile.
2. Associate the detected sound to the nearest identified sound source sₙ and fill spatial information to metadata index d1 or d2 depending on to which one sₙ is associated with.
3. Detect the second strongest direction θ₂ and energy ratio r₂.
4. Find the nearest identified sound source sₙ′ for θ₂ and find to which metadata index sₙ′ is associated to.

If sₙ′ and sₙ are associated with different metadata index, write direction θ₂ and energy ratio r₂ to given index.

Else write direction θ₂ and energy ratio 0 to direction index which has not been used yet. Setting the energy ratio to 0 indicates that there is not real content in the given direction and excluding the source in direction θ₁ the remaining part of the signal should be considered as ambience.

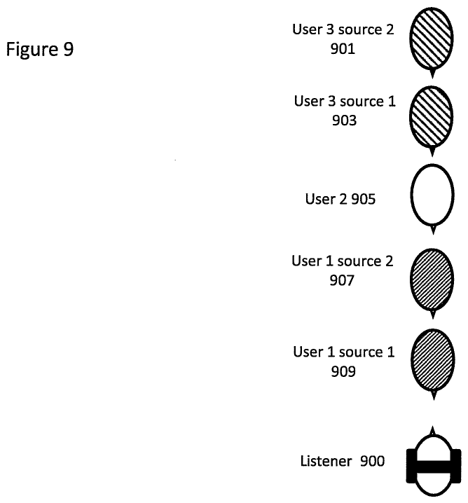

In the spatial mixer audio streams from several clients can be combined. The most simple solution is to make all signals mono and play them as mono. Then all the participants can be heard from the same direction. This is shown for example in FIG. 9. In such embodiments the listener 900 is shown hearing the user 1 source 1 909, user 1 source 2 907, user 2 905, user 3 source 1 903, and user 3 source 2 901 as coming from the same direction, straight forward.

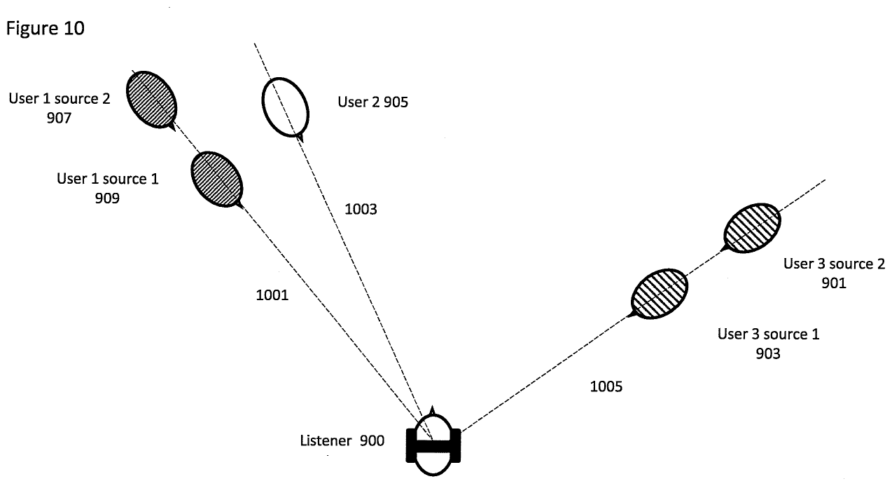

As discussed earlier, in some embodiment by employing spatial information it is possible to make the conference situation more natural for the user and it is easier for to listener to separate individual speakers from each other. For example as shown in FIG. 10 there is shown the implementation of the method to spatialize the audio from multiple sources is to make each signal mono and pan them into selected, stream specific direction.

This is shown for example in FIG. 10 where the listener 900 is shown hearing the user 1 source 1 909 and user 1 source 2 907 from a first direction 1001, user 2 905 from a second direction 1003, and user 3 source 1 903, and user 3 source 2 901 from a third direction 1005. In such an example the sounds originating from three users mixed in a teleconference server for the listener reproduce sound sources which are from the same location are played back from the same direction.

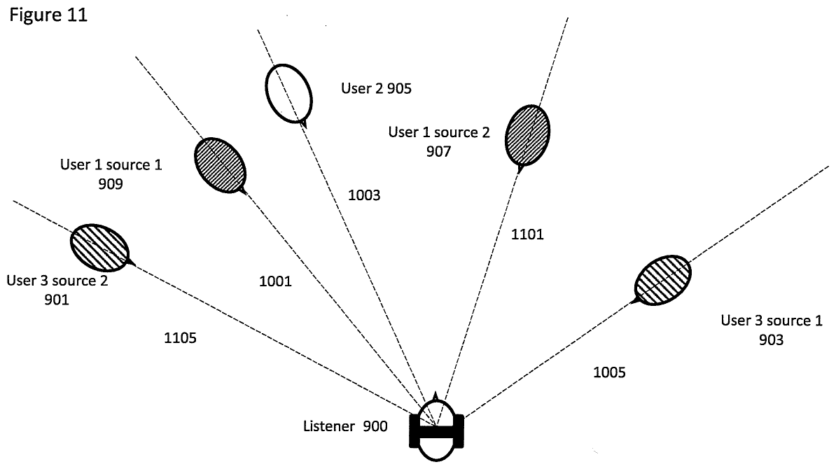

As shown in FIG. 11, in some embodiments where there is determined two (or more) direction indexes in the metadata then the server is configured to separate sources from each client into two directions. Thus the example shown in FIG. 11 where the listener 900 is shown hearing the user 1 source 1 909 from a first direction 1001 and user 1 source 2 907 from a second direction 1101, user 2 905 from a third direction 1003, user 3 source 1 903 from a fourth direction 1005 and user 3 source 2 901 from a fifth direction 1105. This example thus shows that the audio signal from user 2 is played back as mono, whereas from users 1 and 3 there are two separate sources for both. All users/sources are allocated into selected virtual direction around the listener.

In some embodiments this can be implemented as follows:

Let β₁ and β₂ be the two angles for spatial sources which are allocated for the current uplink stream. The metadata modifier is configured to modify the metadata of the stream as follows:
Replace all direction angles in metadata index d1 with β₁
Replace all direction angles in metadata index d2 with β₂
Keep energy ratio information intact.

Now when the modified metadata and the audio signal is fed into spatial synthesis, a spatial signal is generated where all sound sources associated with direction index d1 can be heard from angle β₁ and sources associated with d2 from angle β₂, respectively.

In such embodiments an ambience signal can be still heard as ambience or if desired it can be steered towards sound source directions for example in relation of energy ratios using

$${\hat{r}}_{1} = {r}_{1} + \frac{{r}_{1}}{{r}_{1} + {r}_{2}} ( 1 - {r}_{1} - {r}_{2} ) \\ {\hat{r}}_{2} = {r}_{2} + \frac{{r}_{2}}{{r}_{1} + {r}_{2}} ( 1 - {r}_{1} - {r}_{2} )$$

where it is assumed that energy ratios get values between 0 and 1, the sum of r₁ and r₂ is smaller or equal to one, and \hat{r}ₙ is the updated energy ratio to direction n.

After spatial synthesis, in some embodiment, all the synthesized signals from different clients are added together forming the mixed audio signal which is then encoded and delivered to the client.

In some embodiments rather than fully determining sound objects directions the capture device may be configured to divide the space (for example the 360 degrees) around it into ranges, for example first range 0 . . . 180 degrees and second range 0 . . . −180 degrees. In some embodiments a first direction is always limited to be within the first range and second direction within the second range. If there are no sound directions found within the respective range, then that direction is not used (i.e. energy ratio is set to zero).

In this manner, in some embodiments, the first direction is associated only to sound sources that are to the right of the device and second direction is always associated with sound sources that are to the left of the device.

In some embodiments the first range may be the device camera field of view and the second range all other directions.

In the examples described herein it has been assumed that there are two direction indexes available as is the case with IVAS standard. It should be understood that the invention can be extended to three or more direction indexes if available without significant design changes.

The invention enables low bit rate coding as the separate audio objects can be maintained in one audio stream and there is no need to first separate objects and to encode objects individually. Since the number of direction indexes is fixed, the information of the number of objects does not have to be encoded to the bit stream. In addition there is no need to encode multiple objects in the same direction separately. Despite of efficient compression the invention enables multiple opportunities to modify identified objects in the decoding stage.

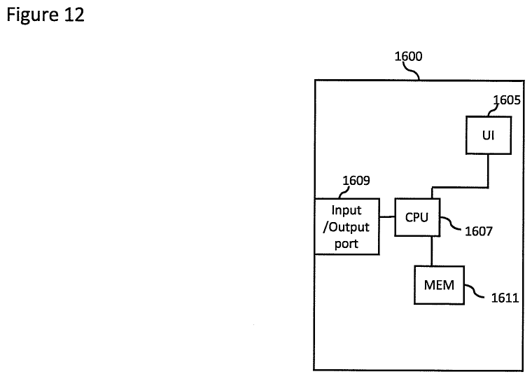

With respect to FIG. 12 an example electronic device which may be used as the computer, encoder processor, decoder processor or any of the functional blocks described herein is shown. The device may be any suitable electronics device or apparatus. For example in some embodiments the device 1600 is a mobile device, user equipment, tablet computer, computer, audio playback apparatus, etc.

In some embodiments the device 1600 comprises at least one processor or central processing unit 1607. The processor 1607 can be configured to execute various program codes such as the methods such as described herein.

In some embodiments the device 1600 comprises a memory 1611. In some embodiments the at least one processor 1607 is coupled to the memory 1611. The memory 1611 can be any suitable storage means. In some embodiments the memory 1611 comprises a program code section for storing program codes implementable upon the processor 1607. Furthermore in some embodiments the memory 1611 can further comprise a stored data section for storing data, for example data that has been processed or to be processed in accordance with the embodiments as described herein. The implemented program code stored within the program code section and the data stored within the stored data section can be retrieved by the processor 1607 whenever needed via the memory-processor coupling.

In some embodiments the device 1600 comprises a user interface 1605. The user interface 1605 can be coupled in some embodiments to the processor 1607. In some embodiments the processor 1607 can control the operation of the user interface 1605 and receive inputs from the user interface 1605. In some embodiments the user interface 1605 can enable a user to input commands to the device 1600, for example via a keypad. In some embodiments the user interface 1605 can enable the user to obtain information from the device 1600. For example the user interface 1605 may comprise a display configured to display information from the device 1600 to the user. The user interface 1605 can in some embodiments comprise a touch screen or touch interface capable of both enabling information to be entered to the device 1600 and further displaying information to the user of the device 1600.

In some embodiments the device 1600 comprises an input/output port 1609. The input/output port 1609 in some embodiments comprises a transceiver. The transceiver in such embodiments can be coupled to the processor 1607 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example in some embodiments the transceiver can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

The transceiver input/output port 1609 may be configured to transmit/receive the audio signals, the bitstream and in some embodiments perform the operations and methods as described above by using the processor 1607 executing suitable code.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media, and optical media.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose-computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. An apparatus for delivering spatial audio, the apparatus comprising:
at least one processor; and
at least one non-transitory memory storing instructions that, when executed with the at least one processor, cause the apparatus to:
obtain at least one audio signal and first metadata and second metadata, the first metadata comprising at least one first spatial parameter associated with a first sound object from a first group of sound objects, and the second metadata comprising at least one second spatial parameter associated with a second sound object from a second group of sound objects; and
low-bitrate encode a spatial audio signal based on the at least one audio signal, the at least one first spatial parameter and the at least one second spatial parameter, wherein the spatial audio signal comprises a controlled version of at least one of the first and second sound objects respectively by the at the at least one first and second spatial parameters.

2. The apparatus as claimed in claim 1, wherein the controlled version of at least one of the first and second sound objects respectively by the at least one first and second spatial parameters causes the apparatus to control at least one of:
amplify audio signals associated with the at least one of the first and second sound objects;
attenuate audio signals associated with the at least one of the first and second sound objects; or
modify at least one of the at least one first and second spatial parameters.

3. The apparatus as claimed in claim 2, wherein the instructions, when executed with the at least one processor, cause the apparatus to modify at least one direction or position for at least one of the at least one first sound object or at least one second sound object.

4. The apparatus as claimed in claim 1, wherein the instructions, when executed with the at least one processor, cause the apparatus to at least partially discard the association between the first metadata and the first sound object from the first group of sound objects and the second metadata and the second sound object from the second group of sound objects.

5. The apparatus as claimed in claim 1, wherein the instructions, when executed with the at least one processor, cause the apparatus to:
obtain a first sound object audio signal and the first metadata;
obtain a second sound object audio signal and the second metadata; and
the instructions, when executed with the at least one processor, cause the apparatus to mix the first sound object audio signal and the second sound object audio signal to generate the spatial audio signal, wherein the mix is based on the at least one first spatial parameter and/or the at least one second spatial parameter.

6. The apparatus as claimed in claim 1, wherein the instructions, when executed with the at least one processor, cause the apparatus to:
identify at least two physical sound sources; and
associate for each of the at least two physical sound sources one of sound objects.

7. The apparatus as claimed in claim 6, wherein the instructions, when executed with the at least one processor, cause the apparatus to apply at least one of:
statistical analysis to the directions or positions to identify directions or positions to which the directions or positions accumulate;
speech detection to identify whether audio signals in the directions or positions are speech to identify at least two physical sound sources; or
face tracking to associated video images to identify at least two physical sound sources.

8. The apparatus as claimed in claim 1, wherein the instructions, when executed with the at least one processor, cause the apparatus to allocate at least one sound source associated with the first metadata and the second metadata consistently to at least one direction or position.

9. The apparatus as claimed in claim 8, wherein the instructions, when executed with the at least one processor, cause the apparatus to allocate at least one sound source associated with the first metadata and the second metadata is configured to at least one of:
detect the direction and energy ratio of a strongest sound;
associate the detected strongest sound to the nearest at least one direction or position;
detect the direction and energy ratio of a second strongest sound; or
associate the detected second strongest sound to the nearest at least one direction or position.

10. A method for an apparatus for delivering spatial audio, the method comprising:
obtaining at least one audio signal and first metadata and second metadata, the first metadata comprising at least one first spatial parameter associated with a first sound object from a first group of sound objects and the second metadata comprising at least one second spatial parameter associated with a second sound object from a second group of sound objects; and
low-bitrate encoding a spatial audio signal based on the at least one audio signal, the at least one first spatial parameter and the at least one second spatial parameter, wherein the spatial audio signal comprises a controlled version of at least one of the first and second sound objects respectively by the at the at least one first and second spatial parameters.

11. The method as claimed in claim 10, wherein the controlled version of at least one of the first and second sound objects respectively by the at least one first and second spatial parameters comprises controlling at least one of:
amplify audio signals associated with the at least one of the first and second sound objects;
attenuate audio signals associated with the at least one of the first and second sound objects; or
modify at least one of the at least one first and second spatial parameters.

12. The method as claimed in claim 11, wherein modifying at least one of the at least one first and second spatial parameters comprises modifying at least one direction or position for at least one of the at least one first sound object or at least one second sound object.

13. The method as claimed in claim 10, wherein the low-bitrate encoding of the spatial audio signal based on the at least one audio signal, the at least one first spatial parameter and the at least one second spatial parameter comprises at least partially discarding the association between the first metadata and the first sound object from the first group of sound objects and the second metadata and the second sound object from the second group of sound objects.

14. The method as claimed in claim 10, wherein obtaining at least one audio signal and first metadata and second metadata comprises:
obtaining a first sound object audio signal and the first metadata;
obtaining a second sound object audio signal and the second metadata; and low-bitrate encoding the spatial audio signal based on the at least one audio signal, the at least one first spatial parameter and the at least one second spatial parameter comprises mixing the first sound object audio signal and the second sound object audio signal to generate the spatial audio signal, wherein the mixing is based on the at least one first spatial parameter and/or the at least one second spatial parameter.

15. The method as claimed in claim 10, wherein obtaining at least one audio signal and first metadata and second metadata comprises:
identifying at least two physical sound sources; and
associating for each of the at least two physical sound sources one of sound objects.

16. The method as claimed in claim 15, wherein identifying at least two physical sound sources comprises at least one of:
applying statistical analysis to the directions or positions to identify directions or positions to which the directions or positions accumulate;
applying speech detection to identify whether audio signals in the directions or positions are speech to identify at least two physical sound sources; or
applying face tracking to associated video images to identify at least two physical sound sources.

17. The method as claimed in claim 10, wherein obtaining at least one audio signal and first metadata and second metadata comprise allocating at least one sound source associated with the first metadata and the second metadata consistently to at least one direction or position.

18. The method as claimed in claim 17, wherein allocating at least one sound source associated with the first metadata and the second metadata comprises at least one of:
detecting the direction and energy ratio of a strongest sound;
associating the detected strongest sound to the nearest at least one direction or position;
detecting the direction and energy ratio of a second strongest sound; or
associating the detected second strongest sound to the nearest at least one direction or position.

19. The method as claimed in claim 10, wherein the method is performed for an application associated with at least one of:
a tele-conference system, where sounds are limited to a direction and local user may control audio objected separately and hear them from different directions;
a spatial audio UI, where sounds are limited to application direction;
an audio recording/telecommunication where user controls one sound object in the mixture but not the other; or
playing audio when a notification appears, and audio direction range is limited.

20. A non-transitory program storage device readable by an apparatus, tangibly embodying a computer program comprising instructions for causing an apparatus to perform at least the following:
obtain at least one audio signal and first metadata and second metadata, the first metadata comprises at least one first spatial parameter associated with a first sound object from a first group of sound objects and the second metadata comprising at least one second spatial parameter associated with a second sound object from a second group of sound objects; and
low-bitrate encode a spatial audio signal based on the at least one audio signal, the at least one first spatial parameter and the at least one second spatial parameter, wherein the spatial audio signal comprises a controlled version of at least one of the first and second sound objects respectively by the at the at least one first and second spatial parameters.
